(19) United States
(12) Patent Application Publication
(10) Pub. No.: US 2018/0224357 A1
(43) Pub. Date: Aug. 9, 2018

(54) CAVITATION-INDUCED EQUILIBRIUM GAS-PHASE SPECTROMETRY

(71) Applicants: Christopher James Hintz, Savannah, GA (US); Kenneth J. Hintz, Fairfax Station, VA (US)

(72) Inventors: Christopher James Hintz, Savannah, GA (US); Kenneth J. Hintz, Fairfax Station, VA (US)

(21) Appl. No.: 15/873,847

(22) Filed: Jan. 17, 2018

Related U.S. Application Data
(60) Provisional application No. 62/447,395, filed on Jan. 17, 2017.

(51) Int. Cl. G01N 1/28; G01N 21/3577

(52) U.S. Cl. CPC G01N 1/286; G01N 2201/023; G01N 21/3577

(57) ABSTRACT

Embodiments of the present disclosure demonstrate cavitating measuring devices. A liquid sample is cavitated to generate bubbles of gas. A frequency-specific radiation is emitted and passes through at least one bubble of gas. The frequency-specific radiation emerges from the bubble of gas as an absorption signal comprising the frequency-specific radiation. The absorption signal is detected and communicated to a system processor. The system processor analyzes the absorption signal data and determines the chemical components present in the liquid sample. Embodiments of the present disclosure describe both static and dynamic liquid samples. The liquid samples can be measured at the sample site.

### CROSS-REFERENCE TO RELATED APPLICATIONS

This application claims the benefit of U.S. Provisional Application No. 62/447,395, filed Jan. 17, 2017, entitled “An apparatus for spectrophometric measurements of equilibrium-gas-phase chemistry created by cavitation,” which is hereby incorporated by reference in its entirety.

### BRIEF DESCRIPTION OF SEVERAL VIEWS OF THE DRAWINGS

FIG. 1 is an embodiment of a cavitating measuring device comprising a cavitator as per an aspect of an embodiment of the disclosure.

FIG. 2 is an embodiment of an example impeller blade of a cavitator of a cavitating measuring device as per an aspect of an embodiment of the disclosure.

FIG. 3 is an embodiment of an example impeller blade of a cavitator of a cavitating measuring device, viewed from an outer edge of the impeller blade as per an aspect of an embodiment of the disclosure.

FIG. 4 is an embodiment of a cavitating measuring device comprising a cavitator and demonstrating a continuous liquid sample flow as per an aspect of an embodiment of the disclosure.

FIG. 5 is an example flow diagram of an example process employing a cavitating measuring device to determine one or more chemical components in a liquid sample as per an aspect of an embodiment of the disclosure.

FIG. 6 is an example flow diagram of a continuous process employing a cavitating measuring device to determine one or more chemical components in a liquid sample as per an aspect of an embodiment of the disclosure.

### DETAILED DESCRIPTION OF EMBODIMENTS

Described below are various embodiments that relate to measurement devices that may detect chemicals and other compounds in a liquid sample at the source of the liquid sample.

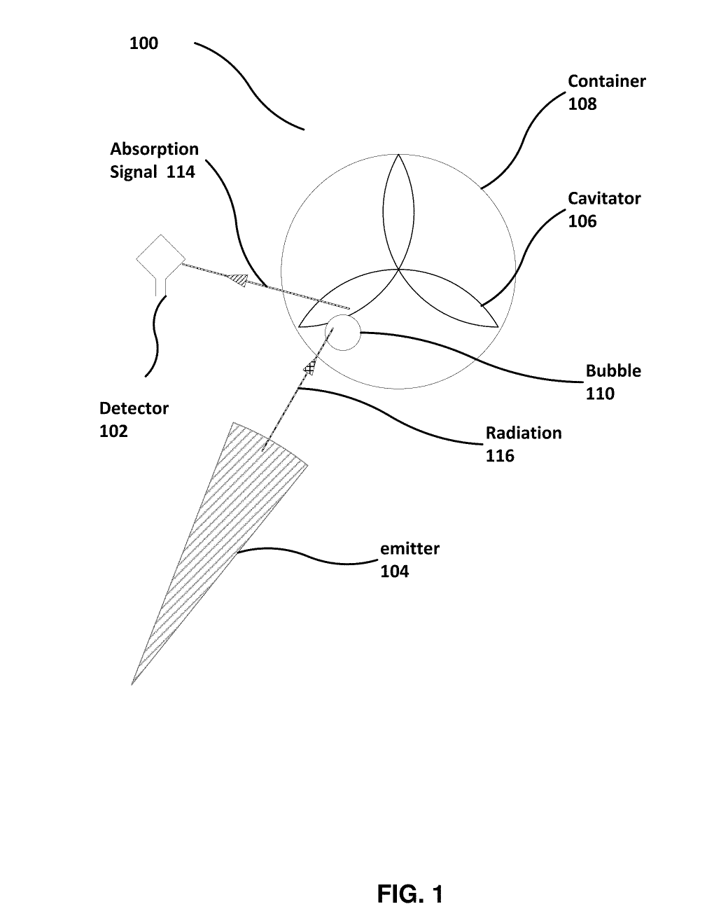

FIG. 1 illustrates an embodiment of a measurement device of the present disclosure. An apparatus 100 may comprise a container 108 surrounding a cavitator 106. An emitter 104 may emit a frequency-specific radiation 116 that may pass through a bubble of gas 110 as an absorption signal 114. Absorption signal may reflect off cavitator 106 and to a detector 102.

The container 108 may enclose a cavitator 106 and may comprise materials known in the art such as metals, polymers, and the like. In an embodiment, the container may have openings, allowing liquid to pass freely through the container such that a continuous stream of liquid passes through the container and the cavitator. The openings may be on opposing ends.

The cavitator 106 may comprise a number of cavitation mechanisms. According to an embodiment, the cavitator may employ an impeller. In another embodiment, the cavitator may be, for example, a Berthelot tube, a centrifuge, or a Venturi device, a combination thereof, and/or the like. An embodiment may cavitate the sample by, for example, an acoustic field, a shock, mineralization, a traveling bubble cavitation, a combination thereof, and/or the like.

The cavitator 106 may generate a bubble of gas 110 within the liquid sample. The bubble of gas 110 may comprise a representation of gases and chemicals present in the liquid sample. For instance, the bubble of gas 110 may comprise oxygen, carbon dioxide, volatile organic compounds, nitrogen, and/or another gas or chemical.

The gas and chemical(s) in the bubble of gas 110 may be detected employing frequency-specific radiation 116. A radiation emitter 104 may generate and direct a frequency-specific radiation 116 through the bubble of gas 110. The frequency-specific radiation 116 may comprise electromagnetic radiation, including, but not limited to, microwaves, radio waves, infrared radiation, visible light, ultraviolet radiation, X-rays, gamma rays, and/or the like. In an embodiment, the frequency-specific radiation 116 may be infrared radiation. After a frequency-specific radiation 116 passes through a bubble of gas 110, it may become an absorption signal 114 that may have characteristics unique to the gas and chemicals present in the bubble of gas 110.

The frequency-specific radiation 116 may pass through a bubble of gas 110 and become an absorption signal 114. The absorption signal 114 may be received by a radiation detector 102. The radiation detector 102 may communicate the absorption signal 114 information to, for example, a signal processor (not shown). In an embodiment, the signal processor (not shown) may determine, based on the absorption signal 114 information, one or more of the chemical and gas components of the bubbles of gas 110.

In an embodiment, the signal processor may use Henry's Law to determine one or more chemical components in one or more bubbles of gas. Henry's Law describes the equilibrium between gas and liquid phase of the bubble of gas 110 based on physical parameters and concentrations in the bubble of gas 110. In an embodiment, the physical parameters may comprise temperature, salinity, a combination thereof and/or the like.

Henry's Law constant is a proportionality factor between the amount of dissolved gas and its partial pressure in a gas phase. Basically, Henry's Law states that at a constant temperature, the amount of a given gas dissolved in a given type of liquid is directly proportional to the partial pressure of the gas in equilibrium with the liquid. Thus, employing the absorption of the bubble of gas 110 measured in gas phase, the pressure of the liquid sample, and Henry's Law constant, Henry's Law may be applied to determine the concentration of one or more chemical components in the liquid sample.

If known samples are available, the Beer-Lambert Law may also be employed. The absorption signal 114 data of the liquid sample may be employed to verify signal matches and determine the concentration of the liquid sample from the absorption in gas phase.

In an embodiment where the cavitator is an impeller, the impeller may be reflective. In such embodiment, the absorption signal 114 may reflect off of the impeller and be directed to the radiation detector 102.

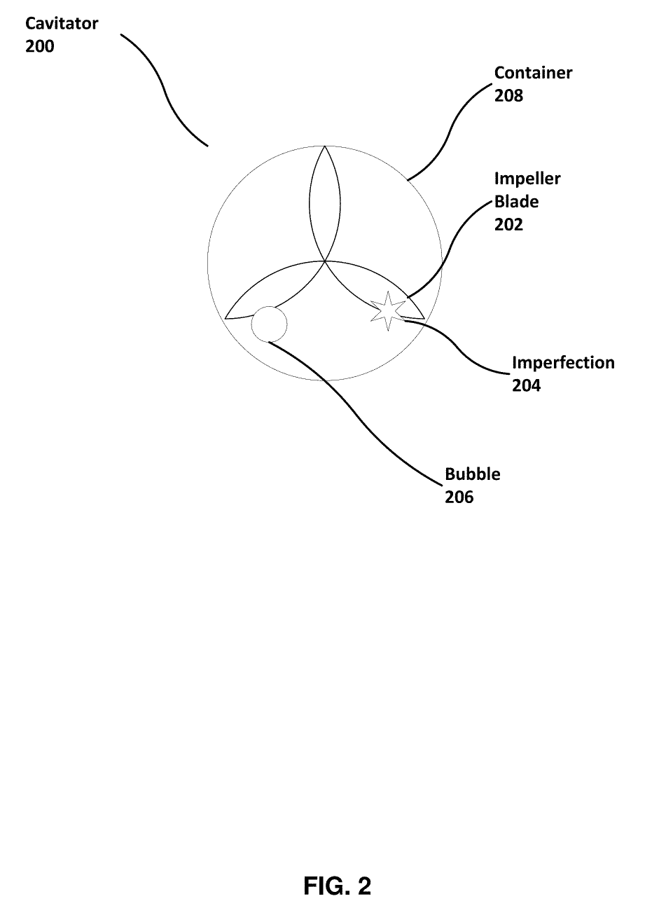

FIG. 2 is an illustration of an example cavitator 200 comprising an impeller. In an embodiment where the cavitator comprises an impeller, FIG. 2 illustrates an impeller blade 202 which may be housed in a container 208. To generate a bubble of gas 206, at least one impeller blade 202 may have an imperfection 204. The imperfection may comprise a crack in the edge of the blade, a chip in the edge of the blade, a divot in the surface of the blade, a combination thereof, and/or another form of imperfection. When the impeller blade or blades rotate around an axis (not shown) of the impeller 202, the imperfection 204 may generate one or more bubbles of gas 206 in the liquid sample. In an embodiment, the impeller blade 202 may comprise a reflective area (not shown).

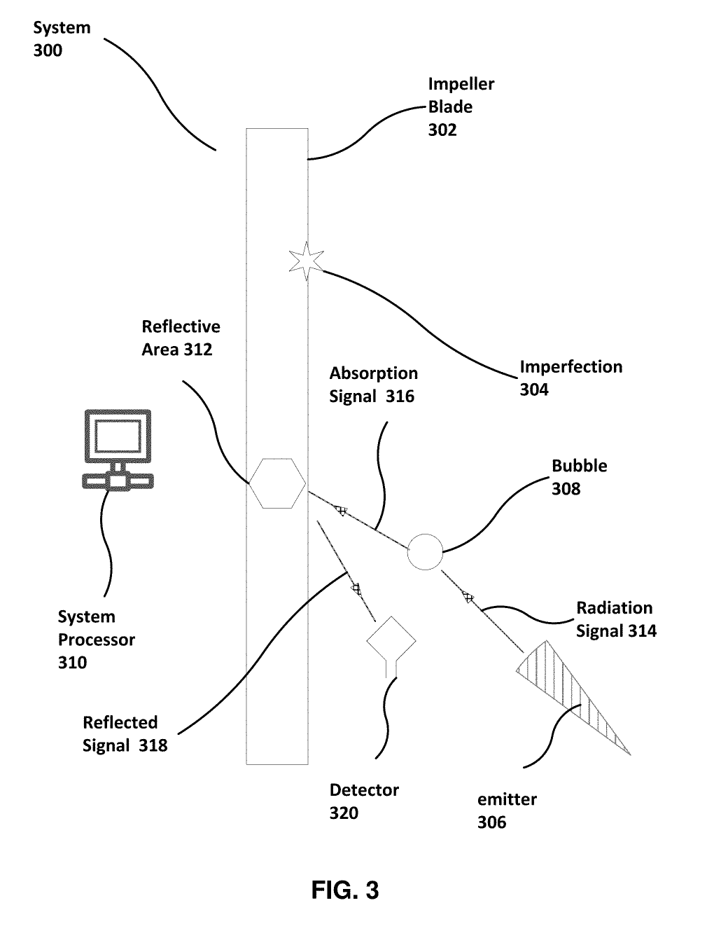

FIG. 3 is an edge view of a system 300 comprising an example impeller blade 302. In an embodiment where the cavitator comprises an impeller, one or more of the impeller blades 302 may comprise an imperfection 304. FIG. 3 shows an example imperfection 304 that may comprise a crack or chip in the edge of an impeller blade. The imperfection 304 may, as the impeller blade 302 rotates around an axis (not shown) of the impeller, generate one or more bubbles of gas 308.

A frequency-specific radiation signal 314 may be directed from an emitter 306 to a bubble of gas 308. The frequency-specific radiation signal may pass through the bubble of gas 308 and emerge as an absorption signal 316. The absorption signal may reflect off of a reflective area 312 of impeller blade 302 producing a reflected signal 318. In an embodiment, the absorption signal 316 may be directed towards a radiation detector 314. The radiation detector 320 may communicate the absorption signal 316 data to a system processor 310. The system processor 310 may determine one or more chemical components of one or more bubble(s) of gas 308.

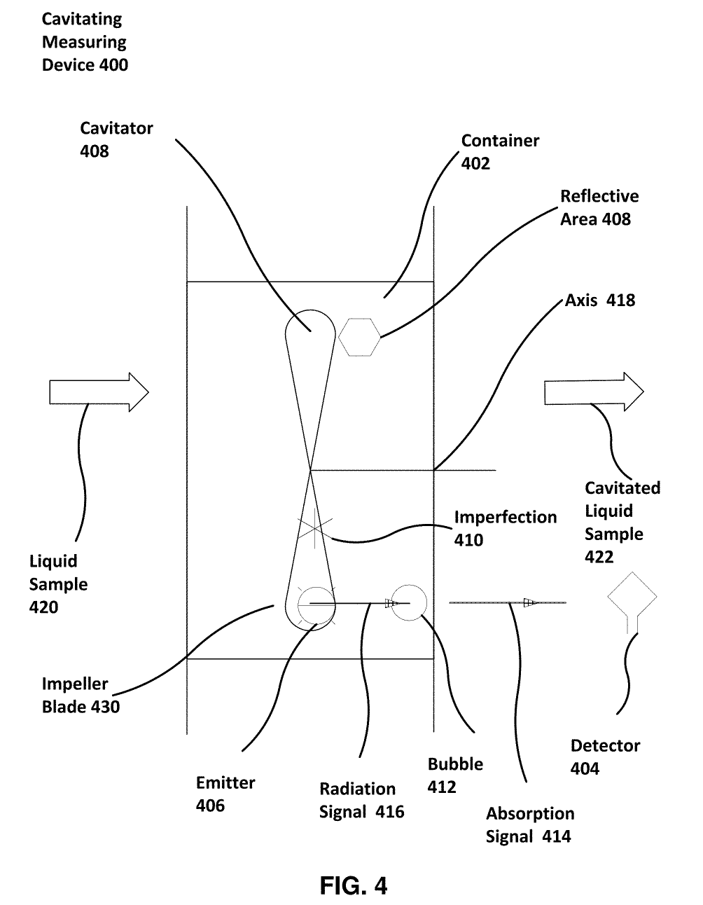

FIG. 4 is a view of an example cavitating measuring device 400. Specifically, FIG. 4 illustrates an example cavitating measuring device 400 according to an embodiment. A container 402 encloses a cavitator 408. In FIG. 4, the cavitator 408 may comprise an impeller. The impeller may have one or more reflective areas 424 on one or more blades of the impeller of cavitator 408.

The cavitating measuring device 400 of FIG. 4 may be completely or partially enclosed. For example, one or more sides of the cavitating measuring device 400 may comprise a void, meaning that one or more sides of the cavitating measuring device 400 may be open to the surrounding atmosphere.

FIG. 4 further illustrates an example imperfection 410 of an impeller blade 430 that may generate at least one bubble of gas 412 by rotating around an axis 418 of the impeller. A radiation emitter 406 may emit a frequency-specific radiation signal 416. The frequency-specific radiation signal 416 may be directed at a bubble of gas 412. The frequency-specific radiation signal 416 may pass through one or more bubbles of gas 412. The frequency-specific radiation signal 416 may emerge from the one or more bubbles of gas 412 as an absorption signal 414. The absorption signal 414 may reflect off of a reflective area of an impeller blade 408. The radiation detector 404 may receive the absorption signal 414.

In an embodiment, the container 402 may fully enclose the cavitator, such that the liquid sample is static. A static liquid sample may be subjected to a cavitator within a cavitating measuring device 400.

In an embodiment, the container 402 may partially enclose a cavitator. A liquid sample may be dynamic as it is subjected to a cavitator within a cavitating measuring device 400. In an embodiment, a liquid sample 420 may be continuous. The liquid sample 420 may enter the apparatus 400 at one opening of the container 402. The cavitated liquid sample 422 may exit the apparatus 400 at a different opening of the container 402. In FIG. 4, the liquid sample 420 enters the container 402 at one open end, passes through the container 402 surrounding the cavitator, and exits the container 402 at an opposing open end. The liquid sample may flow through the container at a specified flow. In these embodiments, the cavitating measuring device may cavitate a continuous flow of liquid. In an embodiment, the cavitating measuring device 400 may measure the components of a bubble of gas 412 in situ, or at the location of the liquid sample, without having to remove the liquid sample from its origin to a secondary location.

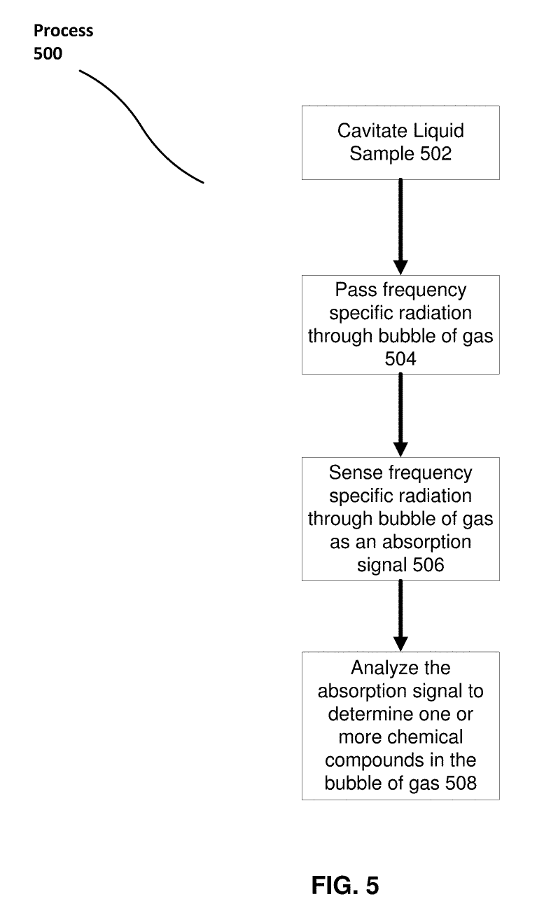

FIG. 5 is a flow chart of an example process 500 employing a cavitating measuring device to determine one or more chemical components in a liquid sample according to an embodiment of this disclosure. The liquid sample may be cavitated at 502. In an embodiment, a frequency-specific radiation may be passed through a bubble of gas at 504 created by cavitating the liquid sample. According to an embodiment, the frequency-specific radiation passing through the bubble of gas may be detected as an absorption signal at 506. The absorption signal may be analyzed to determine one or more chemicals in the bubble of gas at 508.

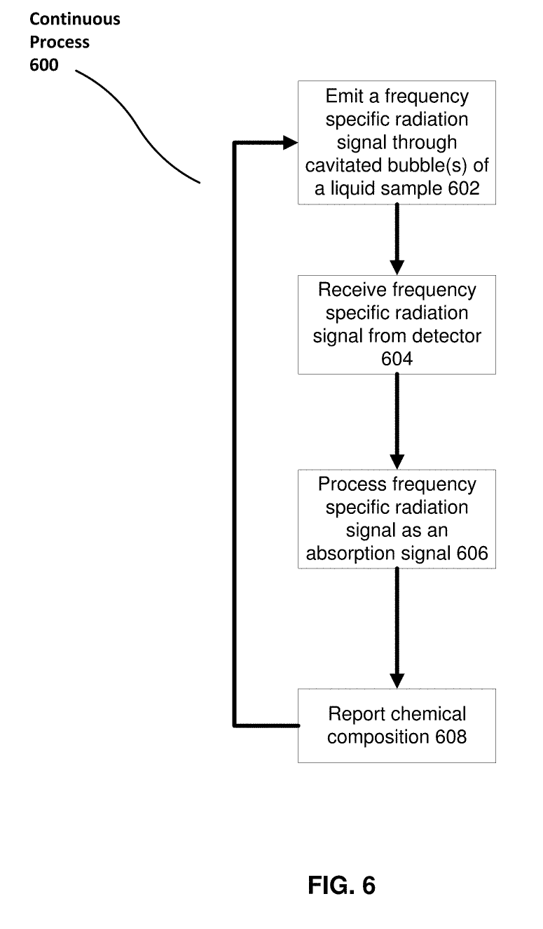

FIG. 6 is a flow diagram of a continuous process 600 employing a cavitating measuring device to determine one or more chemical components in a liquid sample. A frequency-specific radiation signal may be emitted towards a bubble of gas of the liquid sample at 602. According to an embodiment, the frequency-specific radiation may pass through the bubble(s) of gas and emerge as an absorption signal that may be received by a radiation detector at 604. The radiation detector may communicate the absorption data to a signal processor signal at 606. According to an embodiment, the signal processor may determine and report the one or more chemical compositions of the bubble(s) of gas at 608. According to an embodiment, the process 600 may be repeated.

The one or more bubbles of gas of the liquid sample may contain one or more chemical components. In an embodiment, the chemical component may comprise carbon dioxide.

Furthermore, the liquid sample may comprise any one of numerous types of liquids. For example, the liquid sample may comprise ocean water. The liquid sample may comprise pool water, municipal wastewater, power plant reactor water, discharge stream water, a combination thereof and/or the like. The liquid sample may comprise any other sources of liquid that may need to be processed or analyzed according to embodiments described herein.

While various embodiments have been described above, it should be understood that they have been presented by way of example, and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. Thus, the present embodiments should not be limited by any of the above described exemplary embodiments.

In addition, it should be understood that the figures and algorithms, which highlight the functionality and advantages of the present invention, are presented for example purposes only. The architecture of the present invention is sufficiently flexible and configurable, such that it may be utilized in ways other than that shown in the accompanying figures and algorithms. For example, the steps listed in any flowchart may be re-ordered or only optionally used in an embodiment.

It should be noted the terms “including” and “comprising” should be interpreted as meaning “including, but not limited to”.

In this specification, “a” and “an” and similar phrases are to be interpreted as “at least one” and “one or more.” References to “the,” “said,” and similar phrases should be interpreted as “the at least one”, “said at least one”, etc. References to “an” embodiment in this disclosure are not necessarily to the same embodiment.

It is the applicant's intent that only claims that include the express language “means for” or “step for” be interpreted under 35 U.S.C. 112. Claims that do not expressly include the phrase “means for” or “step for” are not to be interpreted under 35 U.S.C. 112.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

1. A process comprising:
cavitating a liquid sample to generate one or more bubbles of gas;
emitting a frequency-specific radiation through the one or more bubbles of gas;
detecting an absorption signal, the absorption signal comprising the frequency-specific radiation after the frequency-specific radiation passes through the one or more bubbles of gas; and,
determining, from the absorption signal, one or more chemical components of the liquid sample.

2. The process of claim 1, further comprising cavitating a continuous flow of liquid.

3. The process of claim 1, wherein the one or more chemical components comprises carbon dioxide.

4. The process of claim 1, wherein the frequency-specific radiation comprises infrared radiation.

5. The process of claim 1, wherein the liquid sample comprises one or more of:
ocean water;
pool water;
municipal wastewater;
a discharge stream; or,
power plant reactor water.

6. The process of claim 1, wherein cavitating the liquid sample further comprises rotating an impeller in the liquid sample.

7. The process of claim 1, wherein cavitating the liquid sample further comprises using one or more of:
rotating an impeller in the liquid sample;
subjecting the liquid sample to a negative pressure in a Berthelot tube;
centrifuging the liquid sample;
shocking the liquid sample;
subjecting the liquid sample to an acoustic field;
mineralizing the liquid sample;
subjecting the liquid sample to a Venturi device; and,
subjecting the liquid sample to a traveling bubble cavitation device.

8. An apparatus comprising:
a cavitation device configured to generate one or more bubbles of gas from a liquid sample;
a radiation emitter configured to direct frequency-specific radiation through the one or more bubbles of gas;
a radiation detector positioned to receive an absorption signal, the absorption signal comprising the frequency-specific radiation after the frequency-specific radiation passes through the one or more bubbles of gas; and,
a signal processor configured to determine, from the absorption signal, one or more chemical components in the liquid sample.

9. The apparatus of claim 8, wherein the one or more chemical components comprises carbon dioxide.

10. The apparatus of claim 8, wherein the frequency-specific radiation comprises infrared radiation.

11. The apparatus of claim 8, wherein the cavitation device comprises one or more of:
an impeller;
a Berthelot tube;
a centrifuge;
a shockwave generator;
an acoustic generator;
mineral inclusions;
a Venturi device; and,
a traveling bubble cavitation device.

12. The apparatus of claim 8, wherein the cavitation device comprises an impeller.

13. The apparatus of claim 8, wherein the cavitation device comprises a reflective component.

14. A method comprising:
cavitating a liquid sample to generate one or more bubbles of gas;
passing a frequency-specific radiation signal through the one or more bubbles of gas;
detecting an absorption signal, the absorption signal comprising the frequency-specific radiation after the frequency-specific radiation passes through the one or more bubbles of gas; and,
determining, from the absorption signal, one or more chemical components of the liquid sample.

15. The method of claim 14, wherein the cavitating further comprises cavitating a continuous flow of liquid.

16. The method of claim 14, wherein the one or more chemical components comprises carbon dioxide.

17. The method of claim 14, wherein the frequency-specific radiation comprises infrared radiation.

18. The method of claim 14, wherein the liquid sample comprises one or more of:
ocean water;
pool water;
municipal wastewater;
a discharge stream; or
power plant reactor water.

19. The method of claim 14, wherein the cavitation further comprises rotating an impeller in the liquid sample.

20. The method of claim 14, wherein the cavitating employs one or more of:
rotating an impeller in the liquid sample;
rotating an reflective impeller in the liquid sample;
subjecting the liquid sample to a negative pressure in a Berthelot tube;
centrifuging the liquid sample;
shocking the liquid sample;
subjecting the liquid sample to an acoustic field;
mineralizing the liquid sample;
subjecting the liquid sample to a Venturi device; and
subjecting the liquid sample to a traveling bubble cavitation device.
